(19) United States
(12) Patent Application Publication
(10) Pub. No.: US 2024/0352794 A1
(43) Pub. Date: Oct. 24, 2024

(54) LADDER COUPLING ASSEMBLY FOR FALL PROTECTION SYSTEM

(71) Applicant: WERNER CO., ITASCA, IL (US)

(72) Inventor: Ivan D. Lopez, Hermitage, PA (US)

(73) Assignee: WERNER CO., ITASCA, IL (US)

(21) Appl. No.: 18/637,910

(22) Filed: Apr. 17, 2024

Related U.S. Application Data
(60) Provisional application No. 63/460,797, filed on Apr. 20, 2023.

(51) Int. Cl. E06C 7/18

(52) U.S. Cl. CPC E06C 7/188; E06C 1/34

(57) ABSTRACT

A ladder coupling assembly includes a pole brace strap formed of flexible webbing and including a rope guide ring structured to guide a rope lifeline, and a buckle structured to selectively attach to a corresponding buckle attached to the rope lifeline, the rope guide ring and buckle disposed proximate a central portion of the pole brace strap, and a rung buckle strap coupled to a central portion of the pole brace strap and formed of flexible webbing and structured to wrap around a first rung or a rail of a ladder proximate an upper portion of the ladder and including rung buckles structured to selectively attach to each other to secure the rung buckle strap in a position wrapped around the first rung or rail of the ladder.

### CROSS REFERENCE TO RELATED APPLICATIONS

This application claims priority to U.S. Patent Application Ser. No. 63/460,797, filed on Apr. 20, 2023 and titled “LADDER COUPLING ASSEMBLY FOR FALL PROTECTION SYSTEM” the disclosure of which is incorporated herein by reference.

### FIELD OF THE INVENTION

The disclosed concept relates generally to fall protection systems and, in particular, to a ladder coupling assembly for a fall protection system for a ladder.

### BACKGROUND OF THE INVENTION

Ladders are well known in the art. A simple ladder includes two elongated rails that are maintained in a spaced relationship by a plurality of rungs extending between the rails. A step ladder, or self-supporting ladder, includes a simple ladder that is pivotally coupled to a brace, or another simple ladder. The pivotal coupling is disposed at the top so the simple ladder and the brace are structured to move between a closed, first configuration, wherein the simple ladder and the brace extend generally parallel to each other, and, an open, second configuration wherein the lower ends of the simple ladder and the brace are spaced from each other. The second configuration is the recommended configuration for use. That is, when in use/second configuration, the step ladder is configured generally as an inverted “V” when viewed from the side. Further, an extension ladder, or “telescopic ladder,” includes two, or more, simple ladders that are slidably coupled to each other and, typically include, a pulley system so that the ladders can be easily extended by an operator on the ground then locked in place using a latching device such as, but not limited to, a pawl. That is, the extension ladder moves between a collapsed, first configuration, wherein the tops and/or bottoms of the ladders are disposed adjacent to each other, and, a second configuration, wherein the ladders are shifted longitudinally relative to each other whereby the extension ladder has a greater length. That is, while the extension ladder may be used in the first configuration, this is also the configuration wherein the extension ladder has a minimal length for storage. If the extension ladder has an insufficient length, the extension ladder is expanded to the second configuration. These are the types of ladders discussed herein. It is understood that other types of ladders also exist.

As is known, a user ascends the ladder by climbing the rungs. As is also well known, many users have been injured either by falling off the ladder and/or having the ladder fall while the user is on the ladder. That is, simple ladders and extension ladders are typically leaned against an object such as, but not limited to, a wall, a pole, a tension member (e.g., a telephone line) or a tree. Further, while not the recommended use, some people lean a step ladder in the first configuration against an object. When the user climbs the ladder, the user may simply slip off, or otherwise fail to maintain contact with the ladder. Alternately, the ladder may slip and/or tilt to such a degree that the ladder and the user fall. These are problems.

One solution to a user falling off a ladder is the use of a safety line assembly, also identified as a lifeline. A safety line assembly includes a tension member such as, but not limited to, a rope and a coupling to the ladder. The safety line is further coupled to the user. That is, once the user is at a height on the ladder wherein a fall could cause injury, the user cinches the safety line so that the user cannot be separated from the ladder. Safety lines, however, also have problems. First, the safety line assembly coupling is disposed at the top of the ladder. The safety line assembly coupling typically includes a mounting and a pulley/retraction device. Thus, when the user is positioning the ladder, the user must lift these elements. As is known, as a ladder is being positioned, the ladder is, essentially, a lever and any mass disposed at the top, such as a safety line assembly, creates a moment arm making the positioning of the ladder difficult. This is a problem.

Further, coupling the safety line assembly to the ladder requires a permanent, cooperative coupling. That is, the coupling requires coupling components on both the ladder and the safety line assembly. For example, the ladder and the safety line assembly mounting have fastener holes through which a bolt or rivet is passed. But, if a ladder is not made with the openings, a user must create openings, i.e., drill holes in the ladder. Given the liability to which ladder manufacturers are exposed, such an action would, typically, void any warranties on the ladder. Thus, the use of a safety line assembly that requires a cooperative coupling is a problem.

Further, such safety line assemblies are, generally, not structured to be moved from one ladder to another. For example, a safety line assembly that is coupled to a ladder by rivets, is permanently coupled to the ladder. That is, to decouple the safety line assembly from the ladder, a user would destroy the rivets. Such a permanent coupling is a problem.

There is room for improvement in fall protection systems for ladders.

### SUMMARY OF THE INVENTION

According to an aspect of the disclosed concept, a ladder coupling assembly comprises: a pole brace strap formed of flexible webbing and including a rope guide ring structured to guide a rope lifeline, and a buckle structured to selectively attach to a corresponding buckle attached to the rope lifeline, the rope guide ring and buckle disposed proximate a central portion of the pole brace strap; and a rung buckle strap coupled to a central portion of the pole brace strap and formed of flexible webbing and structured to wrap around a first rung or a rail of a ladder proximate an upper portion of the ladder and including rung buckles structured to selectively attach to each other to secure the rung buckle strap in a position wrapped around the first rung or rail of the ladder.

According to an aspect of the disclosed concept, a ladder coupling assembly comprises: a pole brace strap formed of flexible webbing and including a rope guide ring structured to guide a rope lifeline and a buckle structured to selectively attach to a corresponding buckle attached to the rope lifeline, the rope guide ring and buckle disposed proximate a central portion of the pole brace strap; and a rung brace strap formed of flexible webbing and structured to attach to a central portion of the pole brace strap, wherein the rung brace strap is structured to attach to a rung of the ladder.

According to an aspect of the disclosed concept, a fall protection system comprises: a rope lifeline including an attachment portion having a rope buckle disposed at a first end; and a ladder coupling assembly including: a pole brace strap formed of flexible webbing and including a rope guide ring structured to guide the rope lifeline, and a buckle structured to selectively attach to the rope buckle, the rope guide ring and buckle disposed proximate a central portion of the pole brace strap; and a rung buckle strap coupled to a central portion of the pole brace strap and formed of flexible webbing and structured to wrap around a first rung or a rail of a ladder proximate an upper portion of the ladder and including rung buckles structured to selectively attach to each other to secure the rung buckle strap in a position wrapped around the first rung or rail of the ladder.

### BRIEF DESCRIPTION OF THE DRAWINGS

A full understanding of the invention can be gained from the following description of the preferred embodiments when read in conjunction with the accompanying drawings in which:

FIG. 1 is a view of a ladder coupling assembly in use in accordance with an example embodiment of the disclosed concept;

FIG. 2 is another view of the ladder coupling assembly of FIG. 1;

FIG. 3 is a view of a ladder coupling assembly in the process of being attached to a pole in accordance with an example embodiment of the disclosed concept;

FIG. 4 is another view of a ladder coupling assembly in the process of being attached to a pole in accordance with an example embodiment of the disclosed concept;

FIG. 5 is an isometric view of a ladder coupling assembly in accordance with an example embodiment of the disclosed concept;

FIG. 6 is an elevation view of a ladder coupling assembly in accordance with an example embodiment of the disclosed concept;

FIG. 7 is a view of a ladder coupling assembly in accordance with an example embodiment of the disclosed concept;

FIG. 8 is a view of a rope attachment in accordance with an example embodiment of the disclosed concept;

FIG. 9 is another view of a rope attachment in accordance with an example embodiment of the disclosed concept;

FIG. 10 is a view of a ladder coupling assembly in use in accordance with an example embodiment of the disclosed concept;

FIG. 11 is a view of a ladder coupling assembly in accordance with an example embodiment of the disclosed concept;

FIG. 12 is a view of a ladder coupling assembly in the process of being attached to a ladder in accordance with an example embodiment of the disclosed concept;

FIG. 13 is a view of a ladder coupling assembly in the process of being attached to a ladder in accordance with an example embodiment of the disclosed concept; and

FIG. 14 is a view of a ladder coupling assembly attached to a ladder in accordance with an example embodiment of the disclosed concept.

### DETAILED DESCRIPTION OF THE INVENTION

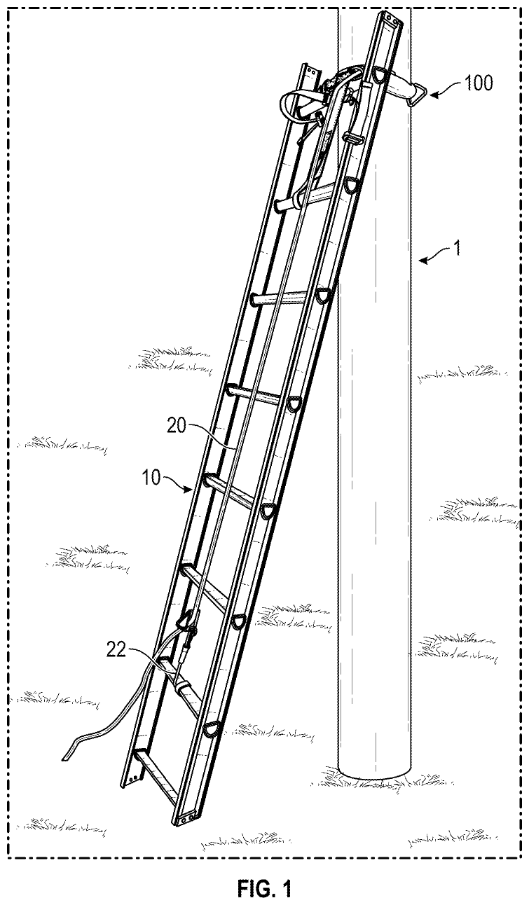

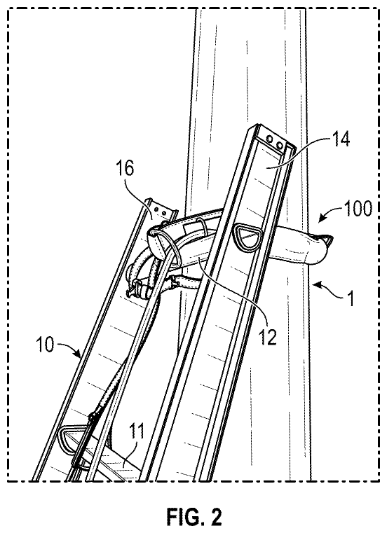

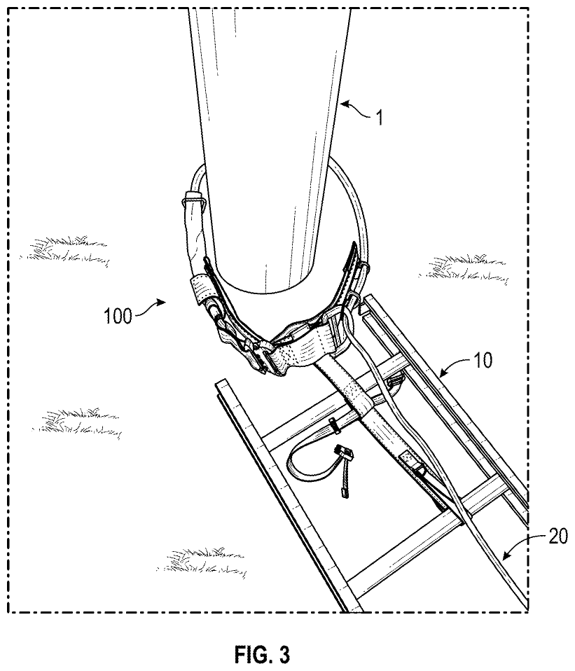

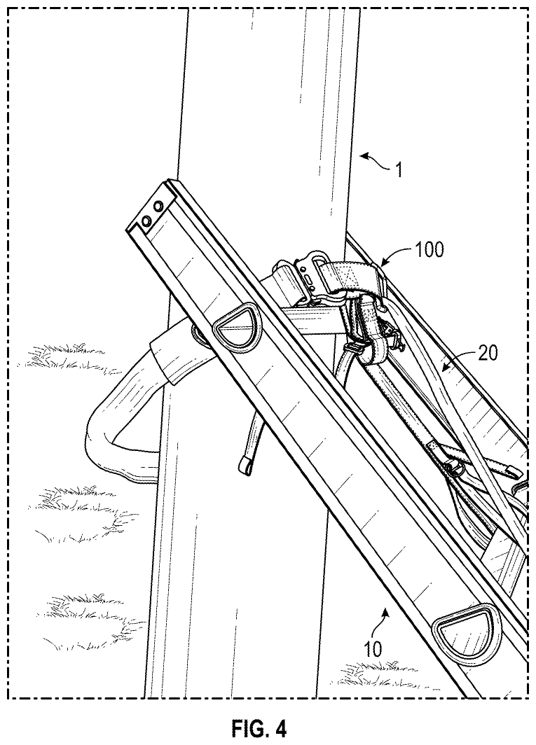

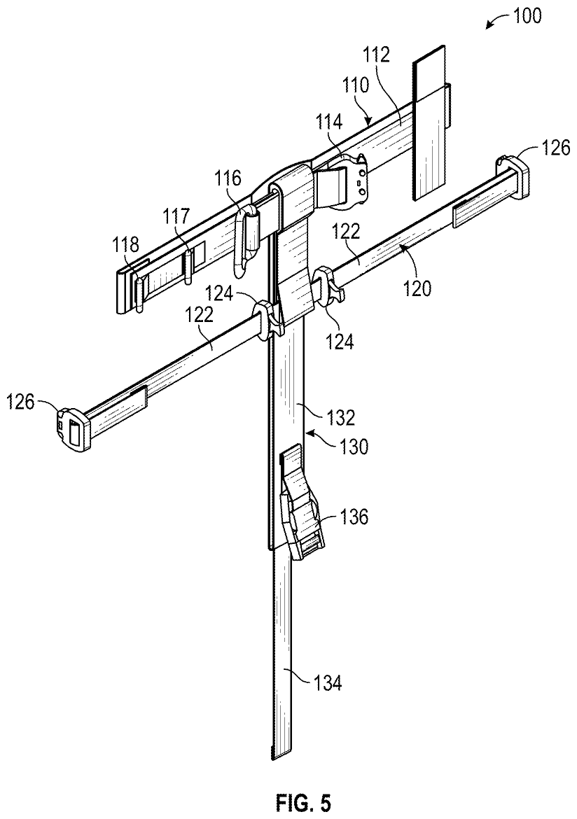

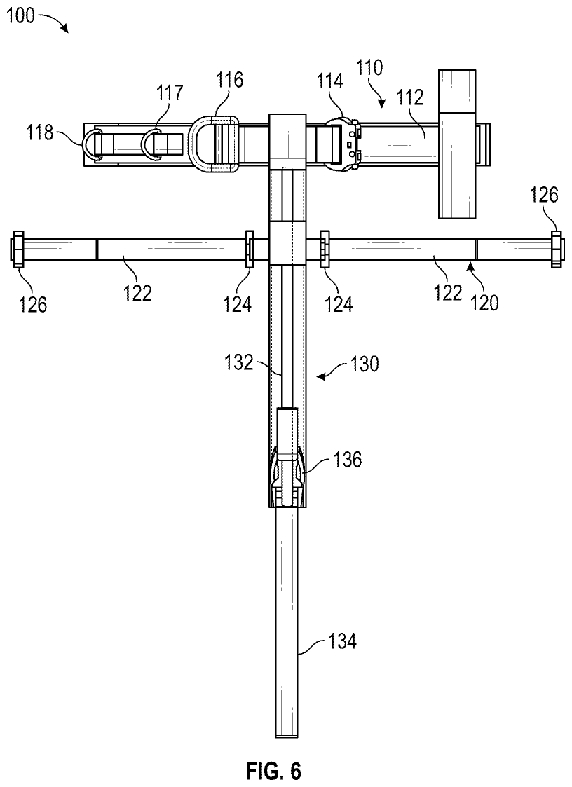

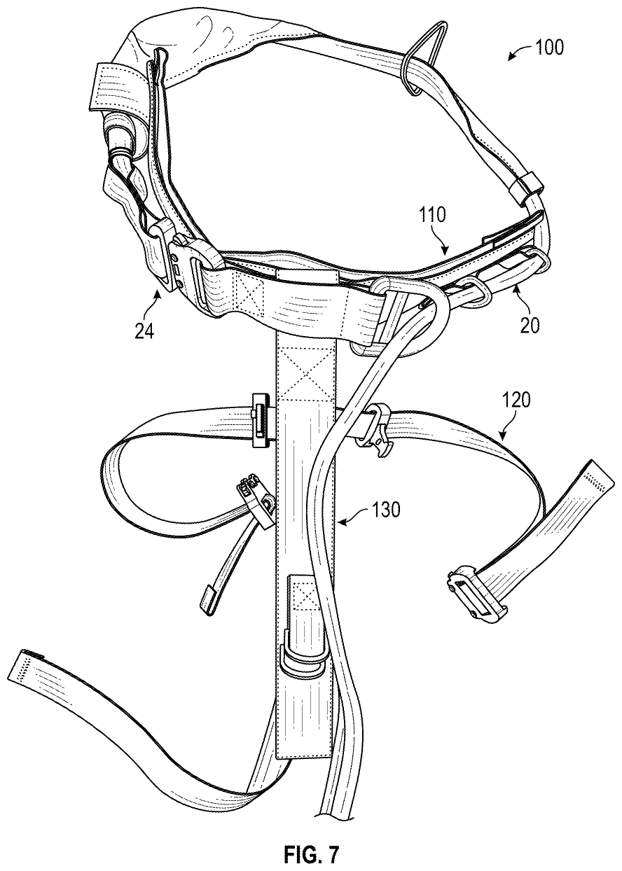

FIGS. 1 and 2 are view of a ladder coupling assembly 100 in use coupling a ladder 10 and a pole 1 in accordance with an example embodiment of the disclosed concept. FIGS. 3 and 4 are views of the ladder coupling assembly 100 in the process of coupling the ladder 10 and the pole 1. FIG. 5 is an isometric view of the ladder coupling assembly 100 and FIG. 6 is an elevation view of the ladder coupling assembly 100. FIG. 7 is another view of the ladder coupling assembly 100.

The ladder coupling assembly 100 is operable to be used with a ladder 10 and a rope lifeline 20 to create a first man up, last man down fall protection system for extension ladders. The ladder coupling assembly 100 is capable of being selectively attached and removed from the ladder 10 as well as being used with different ladders. Similarly, the ladder coupling assembly 100 is capable of being selectively attached and removed from the rope lifeline 20 as well as being used with different ladders. The ladder coupling assembly 100, when attached to the ladder 10 and the pole 1 provides fall protection for a worker in the case of a fall from the ladder 10 via the worker attaching their own fall protection harness to the rope lifeline 20 via a fall arrestor or similar device. The ladder coupling assembly 100 also provides protection by preventing the ladder 10 from falling such as, for example, if the base of the ladder 10 were to slip. That is, the ladder coupling assembly 100 attaches an upper part of the ladder 10 to the pole 1 such that the ladder 10 is secured in an upright position against the pole 1.

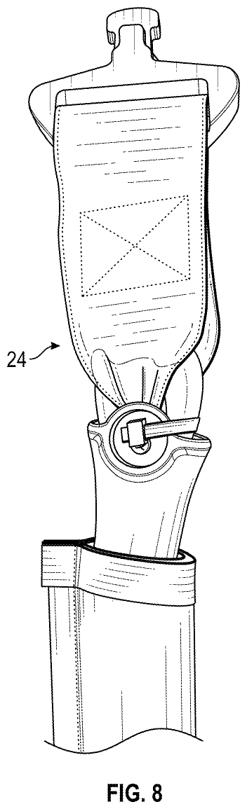

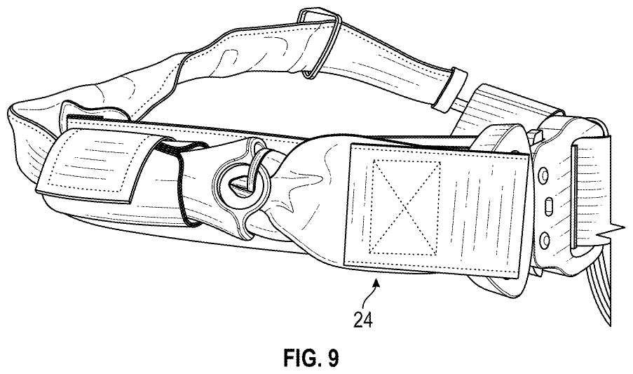

As shown in FIGS. 5 and 6, the ladder coupling assembly 100 includes a pole brace strap assembly 110, a rung buckle assembly 120, and a rung brace strap assembly 130. The pole brace strap assembly 110 includes a pole brace strap 112, a buckle 114, and rope guide rings 116,117,118. The pole brace strap 112 may be made of flexible webbing and structured to extend partially around the circumference of the pole 1. An end of the rope lifeline 20 is structured to extend through the rope guide rings 116,117,118, as shown for example in FIG. 7. A rope attachment 24 including a buckle (shown in FIGS. 8 and 9) is attached to the end of the rope lifeline 20 and the buckle of the rope attachment 24 is structured to be selectively attached to the pole brace buckle 114 of the pole brace strap assembly 110, creating a closed loop formed by the pole brace strap assembly 110 and the rope lifeline 20. The closed loop may be varied in circumference by pushing or pulling the rope lifeline 20 through the rope guide rings 24. When attached to a pole, the closed loop extends around the circumference of the pole and the rope lifeline 20 may be pulled to pull the rope lifeline 20 and pole brace strap assembly 110 tight against the pole. A protective sleeve may also be disposed around un upper part of the rope lifeline 20 to protect the rope lifeline 20 against wear from friction against the pole 1 or parts of the ladder coupling assembly 100 or ladder 10.

In the process of attaching the ladder coupling assembly 100 to a pole, the rope lifeline 20 is extended around the pole at ground level and buckled into the pole brace assembly 110, as shown in FIG. 3. With the rope lifeline 20 and pole brace assembly 110 still loose around the pole 1, the ladder 10 is raised, as shown for example in FIG. 4. Once the ladder 10 reaches the desired height, as shown for example in FIG. 1, the rope lifeline 20 may be pulled from ground level until the rope lifeline 20 and pole brace assembly 110 are tight against the pole 1. The rope lifeline 20 may then be secured to an attachment point 22 on the ladder 10 so that it remains taut and the rope lifeline 20 and pole brace assembly 110 remain tight against the pole 1. At the attachment point 22, the rope lifeline 20 may be tied to the ladder 10 (for example to a rung of the ladder 10), or an attachment device may be used to attach the rope lifeline 20 to the ladder 10 at the attachment point 22. In this manner, the ladder coupling assembly 100 may be used to secure the ladder 10 to the pole 1 and any user, even the first up the ladder 10, may use the rope lifeline 20 for fall protection, for example, by attaching a fall arrestor to the rope lifeline 20 as they ascend the ladder 10.

The ladder coupling assembly 100 further includes a rung buckle strap assembly 120 and a rung brace strap assembly 130. The rung buckle strap assembly 120 and the rung brace strap assembly 130 are operable to selectively attach the ladder coupling assembly 100 to a ladder. It will be appreciated that either or both of the rung buckle strap assembly 120 and the rung brace strap assembly 130 may be used to attach the ladder coupling assembly 100 to the ladder 10.

The rung buckle strap assembly 120 includes rung buckle straps 122 and corresponding rung buckles 124,126. The rung buckle straps 122 may be composed of flexible webbing. The corresponding rung buckles 124,126 include a first rung buckle 124 slidably attached to a rung buckle strap 122 and a second rung buckle 124 adjustably attached to a distal part of the rung buckle strap 122. The rung buckle straps 122 are structured to wrap around a rung 12 of a ladder 10 (shown in FIG. 2). A rung buckle strap 122 is wrapped one or more times around the rung 12 and then the corresponding rung buckles 124,126 are attached to each other to prevent the rung buckle strap 122 from being releasing from the rung 12 until the rung buckles 124,126 are released. In some example embodiments, the ladder coupling assembly 100 includes a pair of rung buckle straps 122. In some example embodiments, the rung buckles straps 122 may be wrapped around the rung 12, a rail 14,16, or a combination of the rung 12 and rail 14,16 of the ladder 10.

The rung brace strap assembly 130 includes rung brace straps 132,134 and a rung brace buckle 136. The rung brace straps 132,134 extend in a direction substantially perpendicular with respect to the pole brace strap 110 and the rung buckle straps 122. The rung brace straps 132,134 are structured to attach the ladder coupling assembly 100 to an adjacent rung 11 of a ladder 10 (shown in FIG. 2) to the rung 12 that the rung strap assembly 120 attaches to. The rung brace straps 132,134 may be made of flexible webbing. The rung brace straps 132 include a first rung brace strap 132 which is attached to the rung buckle strap assembly 120 and the pole brace strap assembly 110, and a second rung brace strap 134 which extends from the first rung brace strap 132. The rung brace buckle 136 is attached to the first rung brace strap 132. The second rung brace strap 134 is structured to wrap around the rung 11 of the ladder 10 and attach to the rung brace buckle 136, thus securing the ladder coupling assembly 100 to the rung 11 of the ladder 10.

In an example embodiment, the rung brace strap 132 extends vertically along a central axis of the ladder coupling assembly 100. The pole brace strap 112 extends horizontally from each side of the rung brace strap 132 at an upper portion of the rung brace strap 132. The pole brace strap 112 is attached to the rung brace strap 132 using any suitable mechanism. In some example embodiment, the pole brace strap 112 may be directed stitched to the rung brace strap 132. In some example embodiments, the pole brace strap 112 may pass through a loop in the rung brace strap 132. The rung buckle straps 122 extend horizontally from sides of the rung brace strap 132 and are attached to the rung brace strap 132. In some example embodiments, the rung buckle straps 122 are stitched to the rung brace strap 132. In some example embodiments, the rung buckle straps 122 pass through a loop of the rung brace strap 132. The rung buckle straps 122 are attached to the rung brace strap 132 at an upper portion of the rung brace strap 132, but below where the pole brace strap 112 is attached to the rung brace strap 132.

The ladder coupling assembly 100 in primarily composed of flexible webbing with the only rigid components being buckles and rings. This makes the ladder coupling assembly 100 lightweight and flexible, while still allowing secure attachment to the ladder 10 and pole 1. As described herein, the ladder coupling assembly 100 also allows setup of the fall protection system from the ground level by extending the rope lifeline 20 through the pole brace assembly 110 and around the pole 1 at ground level and then raising the ladder 10 and pulling the rope lifeline 20 taut and securing it at the attachment point 22. Thus, the ladder coupling assembly 100 allow first man up, last man down fall protection. Additionally, the ladder coupling assembly 100 may be attached or removed from the ladder 10 without tools, and as well, the ladder coupling assembly 100 may be attached or removed from the pole 1 without tools.

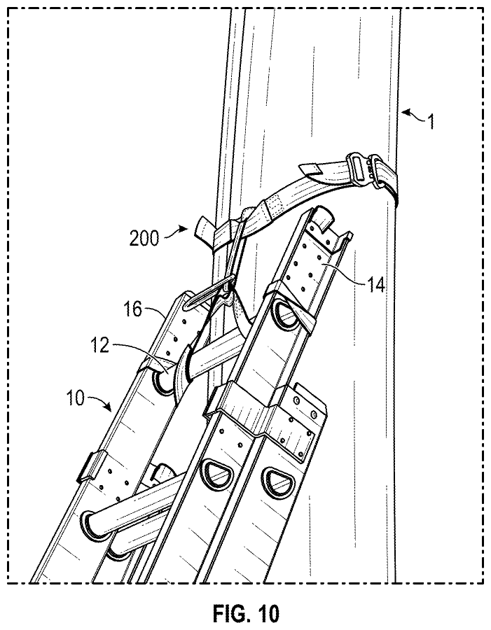

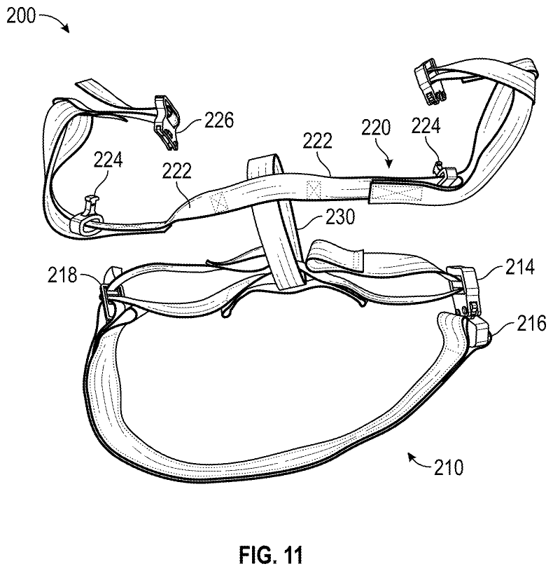

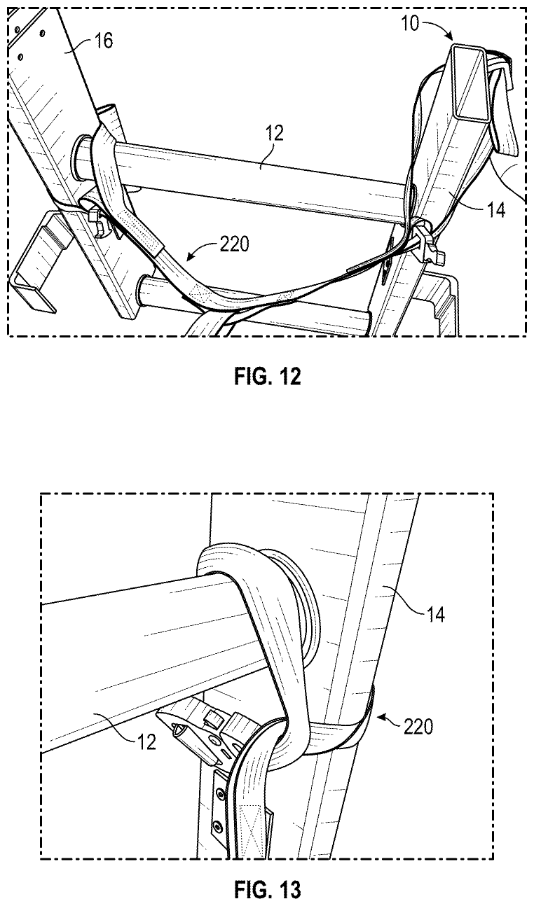

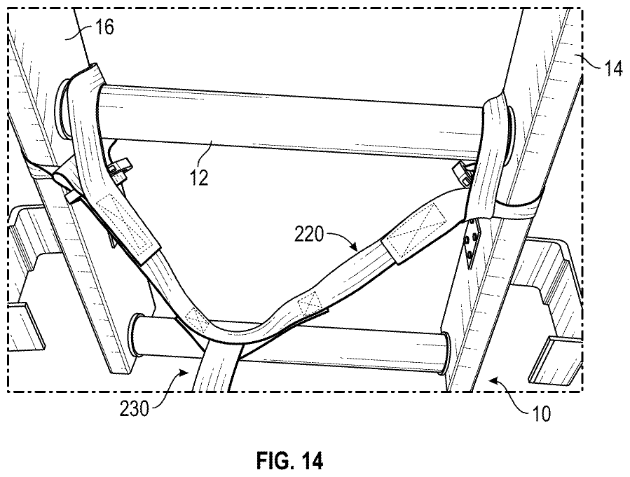

FIG. 10 is a view of a ladder coupling assembly 200 in use in accordance with another example embodiment of the disclosed concept. FIG. 11 is a view of the ladder coupling assembly 200 removed from the ladder 10. FIGS. 12-14 are views of rung buckle straps 220 of the ladder coupling assembly 200 attaching to a rung 12 and rails 14,16 of the ladder 10.

The ladder coupling assembly 200 includes a pole strap 210, a rung buckle strap assembly 220, and a coupling strap 230. The pole strap 210 is composed of flexible webbing and is structured to extend around the circumference of the pole 1. The pole strap 210 includes corresponding buckles 214,216 structured to selectively attach and detach from each other. Connecting the buckles 214,216 causes the pole strap 210 to form a closed loop. Disconnecting the buckles 214,216 from each other opens the loop formed by the pole strap 210 and allows the pole strap 210 to be removed from the pole 1. The pole strap 210 further includes a slidable adjustment member 218 through which a portion of the pole strap 210 passes. The slidable adjustment member 218 allows the pole strap 210 to be tightened or loosened by pulling the pole strap 210 through the slidable adjustment member 218 in respective directions. The pole strap 210 may be placed around the pole 1 at ground level by encircling the pole strap 210 loosely around the pole 1 and attaching the buckles 214,216 to each other. The ladder 10 may then be raised, and when it is in the desired position, the pole strap 210 may be pulled through the pole strap adjustment member 218 to tighten the pole strap 210 against the pole 1. The pole strap 210 may also be place around the pole 1 after the ladder 10 is raised to the desired height.

The rung buckle strap assembly 220 is structured to attach the ladder coupling assembly 200 to the ladder 10. The pole strap 210 and the rung buckle strap assembly 220 are attached together via the coupling strap 230. In some example embodiments, the coupling strap 230 is a flexible loop of webbing that is attached to the pole strap 210 and the rung buckle strap assembly 220 via stitching, loops, combinations thereof, or any other suitable mechanisms. The coupling strap 230 may also accommodate connection to a lifeline via an attachment mechanism such as a carabiner attached to the lifeline or by directly attaching the lifeline to the coupling strap 230.

The rung buckle strap assembly 220 includes rung buckle straps 222 and corresponding rung buckles 224,226. The rung buckles straps 222 are structured to be wrapped around the rung 12 and rails 14,16 of the ladder 10 and then the rung buckles 224,226 are attached to each other to secure the rung buckle straps 222 in their position wrapped around the rung 12 and rails 14,16 of the ladder 10. Examples of the rung buckles straps 222 being wrapped around and secured to the rung 12 and rails 14,16 of the ladder are shown in FIGS. 12-14.

When the rung buckle strap assembly 210 is attached to the rung 12 and rails 14,16 of the ladder 10 and the pole strap 210 is attached to the pole 1, the ladder coupling assembly 200 secures the ladder 10 to the pole 1 and prevents the ladder 10 from falling. Additionally, when a lifeline is attached to the coupling strap 230, the lifeline provides a connection point that a worker can attach to for fall protection while ascending or descending the ladder 10.

The ladder coupling assembly 200 provides a lightweight and flexible mechanism for providing fall protection for ladders. The ladder coupling assembly 200 may be easily attached and detached from ladders without the use of tools, and can be used with a wide variety of ladders.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A ladder coupling assembly comprising:
a pole brace strap formed of flexible webbing and including a rope guide ring structured to guide a rope lifeline, and a buckle structured to selectively attach to a corresponding buckle attached to the rope lifeline, the rope guide ring and buckle disposed proximate a central portion of the pole brace strap; and
a rung buckle strap coupled to a central portion of the pole brace strap and formed of flexible webbing and structured to wrap around a first rung or a rail of a ladder proximate an upper portion of the ladder and including rung buckles structured to selectively attach to each other to secure the rung buckle strap in a position wrapped around the first rung or rail of the ladder.

2. The ladder coupling assembly of claim 1, further comprising:
a rung brace strap formed of flexible webbing and structured to attach to central portions of the pole brace strap and rung buckle strap, wherein the rung brace strap is structured to attach to a second rung of the ladder adjacent to the first rung of the ladder.

3. The ladder coupling assembly of claim 2, wherein the rung brace strap includes a rung brace attachment, wherein the rung brace strap is structured to wrap around the second rung of the ladder, and wherein the rung brace attachment is structured to secure the rung brace strap in a position wrapped around the second rung of the ladder.

4. The ladder coupling assembly of claim 2, wherein the rung brace strap extends is a first direction and the pole brace strap and rung buckle strap extend in directions perpendicular to the first direction.

5. The ladder coupling assembly of claim 2, wherein the rung brace strap is attached to the pole brace strap or the rung buckle strap by stitching.

6. The ladder coupling assembly of claim 2, wherein the rung brace strap includes a loop, and wherein the pole brace strap or the rung buckle strap are attached to the rung brace strap by passing the pole brace strap or the rung buckle strap through the loop.

7. The ladder coupling assembly of claim 1, wherein the pole brace strap is structured to wrap around a portion of a circumference of a pole.

8. The ladder coupling assembly of claim 1, wherein the pole brace strap includes at least one additional rope guide ring, the additional rope guide ring disposed proximate a distal portion of the pole brace strap.

9. The ladder coupling assembly of claim 8, wherein the pole brace strap is structured such that when the corresponding buckle of the rope lifeline is attached to the buckle of the pole brace strap and the rope lifeline is guided through the rope guide ring and the at least one additional rope guide ring, the rope lifeline and the pole brace strap form a closed loop.

10. The ladder coupling assembly of claim 1, wherein the rung buckle strap is structured to wrap around the first rung and the rail of the ladder, and wherein the rung buckles are structured to selectively attach to each other to secure the rung buckle strap in a position wrapped around the first rung and the rail of the ladder.

11. The ladder coupling assembly of claim 1, wherein the rung buckles includes a first rung buckle slidably attached to the rung buckle strap and a second rung buckle adjustably attached to a distal part of the rung buckle strap.

12. A ladder coupling assembly comprising:
a pole brace strap formed of flexible webbing and including a rope guide ring structured to guide a rope lifeline and a buckle structured to selectively attach to a corresponding buckle attached to the rope lifeline, the rope guide ring and buckle disposed proximate a central portion of the pole brace strap; and
a rung brace strap formed of flexible webbing and structured to attach to a central portion of the pole brace strap, wherein the rung brace strap is structured to attach to a rung of the ladder.

13. The ladder coupling assembly of claim 12, wherein the rung brace strap includes a rung brace attachment, wherein the rung brace strap is structured to wrap around the second rung of the ladder, and wherein the rung brace attachment is structured to secure the rung brace strap in a position wrapped around the second rung of the ladder.

14. The ladder coupling assembly of claim 12, wherein the rung brace strap extends is a first direction and the pole brace strap extends outward from the rung brace strap in directions perpendicular to the first direction.

15. The ladder coupling assembly of claim 12, wherein the pole brace strap includes at least one additional rope guide ring, the additional rope guide ring disposed proximate a distal portion of the pole brace strap.

16. The ladder coupling assembly of claim 15, wherein the pole brace strap is structured such that when the corresponding buckle of the rope lifeline is attached to the buckle of the pole brace strap and the rope lifeline is guided through the rope guide ring and the at least one additional rope guide ring, the rope lifeline and the pole brace strap form a closed loop.

17. A fall protection system comprising:
a rope lifeline including an attachment portion having a rope buckle disposed at a first end; and
a ladder coupling assembly including:
a pole brace strap formed of flexible webbing and including a rope guide ring structured to guide the rope lifeline, and a buckle structured to selectively attach to the rope buckle, the rope guide ring and buckle disposed proximate a central portion of the pole brace strap; and
a rung buckle strap coupled to a central portion of the pole brace strap and formed of flexible webbing and structured to wrap around a first rung or a rail of a ladder proximate an upper portion of the ladder and including rung buckles structured to selectively attach to each other to secure the rung buckle strap in a position wrapped around the first rung or rail of the ladder.

18. The fall protection system of claim 17, wherein the pole brace strap is structured such that when the rope buckle is attached to the buckle of the pole brace strap and the rope lifeline is guided through the rope guide ring, the rope lifeline and the pole brace strap form a closed loop.

19. The fall protection system of claim 18, wherein the rope lifeline is structured to extend through rope guide ring and down to a lower portion of the ladder.

20. The fall protection system of claim 19, wherein the pole brace strap and rope lifeline are structured such that pulling on the rope lifeline from the lower portion of the ladder causes a circumference of the closed loop formed by the rope lifeline and pole brace strap to be reduced.
